(19) United States
(12) Patent Application Publication
(10) Pub. No.: US 2005/0198206 A1
(43) Pub. Date: Sep. 8, 2005

(54) Method and apparatus for dynamically selecting functionally equivalent Web services through a single autonomic proxy

(75) Inventors: Steven Michael Miller, Cary, NC (US); Mark Douglas Weitzel, Durham, NC (US)

Correspondence Address: DUKE W. YEE, YEE & ASSOCIATES, P.C., P.O. BOX 802333, DALLAS, TX, 75380, US

(73) Assignee: International Business Machines Corporation, Armonk, NY (US)

(21) Appl. No.: 10/768,201

(22) Filed: Jan. 30, 2004

(51) Int. Cl. G06F 15/16

(52) U.S. Cl. 709/219; 709/203

(57) ABSTRACT

A method and system for dynamically selecting functionally equivalent web services through a single autonomic proxy. The present invention addresses quality of service issues common in the Web service environment, such as failover, redundancy, performance, and security. The present invention dynamically tunes the Web service environment by allowing an autonomic proxy to determine which Web service, from multiple functionally equivalent Web services, to invoke. When a client request to locate a Web service is received, an autonomic proxy queries the UDDI registry based on the client request. The autonomic proxy locates multiple Web services candidates to service the request, wherein each Web service candidate is functionally equivalent to the other Web service candidates. The present invention may also apply policies based upon non-technical attributes of a service, e.g. business criteria. Such business criteria may be a preferred vendor or business partner or the cost of the service.

### BACKGROUND OF THE INVENTION

1. Technical Field

The present invention relates to an improved computing system. More particularly, the present invention relates to a method and apparatus for dynamically selecting functionally equivalent web services through a single autonomic proxy.

2. Description of Related Art

A Web service is a business application that may be published to a network as a service for remote access and invocation by client-side programs. Web services may be invoked via defined interfaces that are described in forms that are discoverable by other software components over the network. Industry groups work together to define a set of standard Wed service interfaces. These Web service interfaces are typically (but not required to be) based on XML (extensible markup language)-derived markup languages for all aspects of data exchange and are defined by Web services protocols and languages including SOAP (simple object access protocol), UDDI (universal description, discovery, and integration), and WSDL (web service description language). Each of these protocols and languages is defined by a standard specification. SOAP and WSDL are defined by W3C (World Wide Web Consortium) standard documents, while UDDI is defined by a standard promulgated by OASIS (Organization for the Advancement of Structured Information Standards), a non-profit industry consortium devoted to the establishment of standards for electronic business.

UDDI is a form of distributed database for storing and retrieving information about Web services. UDDI is similar in design to DNS (Domain Name Service), which is the distributed database used to map character-based domain names (e.g., “www.ibm.com”) into numerical network addresses for use in routing packets over the Internet. UDDI might also be analogized to a telephone book. Whereas DNS is like the “white pages” (mapping a name to an address), however, UDDI is a bit more like the “yellow pages,” mapping service attributes into service locations and descriptions.

A UDDI registry contains information about Web services. Since UDDI is a distributed database standard, a registry may span a number of different UDDI servers, and, much like DNS, each server is capable of consulting other servers to locate desired Web services. An entry in a UDDI registry will provide information about a particular Web service, including its location (e.g., a URL or uniform resource locator), information about how to use the service (e.g., as an XML Schema or as a WSDL document), and other attributes that may be useful in identifying a desired service. A client wishing to locate a Web service to meet particular needs can query the UDDI registry to locate entries for Web services that meet those needs. A consortium of companies, including IBM, Microsoft, and other major vendors, have established a public UDDI registry that may be used, much like DNS, as a master directory to locate listed Web services. Typically, a UDDI registry will itself be implemented using Web services, so that SOAP or some other comparable protocol can be used for storing or retrieving UDDI registry information.

UDDI is designed to store information about Web services according to classification schemes. UDDI registries may be available to the general public, or only available to specified companies or industry groups. Public business registries include classification schemes such as the Universal Standard Products and Services Classification scheme (UNSPSC) that allow a service requester to select an appropriate business category to search. Private registries, not available to the general public, may be used to increase business security via controlled accesses to services by selecting acceptable participants. These private registries may be used for integrating supply chains, building trading communities, and collaborating with business partners. UDDI does not require the use of any particular classification scheme, and a UDDI entry may include any number of classifications for the purpose of assisting searches. Thus, UDDI provides a convenient way of organizing and indexing information by category or type.

The Web service-related information stored by UDDI registries need not be encoded in any particular language. WSDL, an XML-derived markup language, is specifically designed for encoding descriptive information about Web services. WSDL may be used to describe the abstract interface and protocol bindings of arbitrary network services.

Web service interfaces may be defined using the industry standard WSDL and published to the global UDDI registry. As a result, when vendors and other interested parties want to interact with members of these industry groups, the vendors register an implementation of the published interface in UDDI registry. After registering with UDDI, industry group members searching for implementers of the interface may dynamically discover these new vendors. Since multiple vendors have published services that conform to the same interface (as defined by WSDL), the services are said to be functionally equivalent.

Conventional Web service environments may employ proxies to evaluate client requests for a Web service, relay the requests from the client to the Web server, and relay the Web server's answers back to the client. However, typical proxy implementations utilize only one of the potential service implementations returned from a Web service search.

Thus, it would be advantageous to have a method and system for dynamically tuning the Web services environment by providing an autonomic proxy that is able to message multiple functionally equivalent Web services on behalf of the client. Furthermore, it would be advantageous to provide a mechanism for utilizing pluggable algorithms to determine the order of Web service substitution.

### SUMMARY OF THE INVENTION

The present invention provides a method and system for dynamically selecting functionally equivalent web services through a single autonomic proxy. The present invention addresses quality of service issues common in the Web service environment, such as failover, redundancy, performance, and security. The present invention may also apply policies based upon non-technical attributes of a service, e.g. business criteria. Such business criteria may be a preferred vendor or business partner or the cost of the service.

The mechanism of the present invention dynamically tunes the Web service environment by allowing an autonomic proxy to determine which Web service, from multiple equivalent Web services, to invoke. A proxy is first configured based on a specific interface found by a wsdlSpec tModel. The policies, which may be specified at the time of deployment, are then matched with policies explicitly expressed by the Web service. When a client request is received, the proxy examines the metadata about the request (e.g., the Web service response time) to determine if the request matches the Web service policy. If the request matches the Web service policy, the autonomic proxy queries the UDDI registry based on the client request. The autonomic proxy then locates multiple Web services candidates to service the client request, wherein each Web service candidate is functionally equivalent to the other Web service candidates.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a network of data processing system in which the present invention may be implemented;

FIG. 2 is a block diagram of a data processing system that may be implemented as a server in accordance with a preferred embodiment of the present invention;

FIG. 3 is a block diagram illustrating a data processing system in which the present invention may be implemented;

FIGS. 4A and 4B are block diagrams illustrating components used in dynamically selecting functionally equivalent Web application servers through a single autonomic proxy in accordance with a preferred embodiment of the present invention;

FIG. 5 is a diagram of a process by which an autonomic proxy may message multiple functionally equivalent Web services in accordance with a preferred embodiment of the present invention;

FIG. 6 is a flowchart of a process by which an autonomic proxy may automatically select the next appropriate service implementer to provide a degree of failover to the web service environment in accordance with a preferred embodiment of the present invention; and

FIG. 7 is a flowchart of a process by which an autonomic proxy may analyze the Web service response times and dynamically selects the proxy responding the quickest in accordance with a preferred embodiment of the present invention.

### DETAILED DESCRIPTION OF THE PREFERRED EMBODIMENT

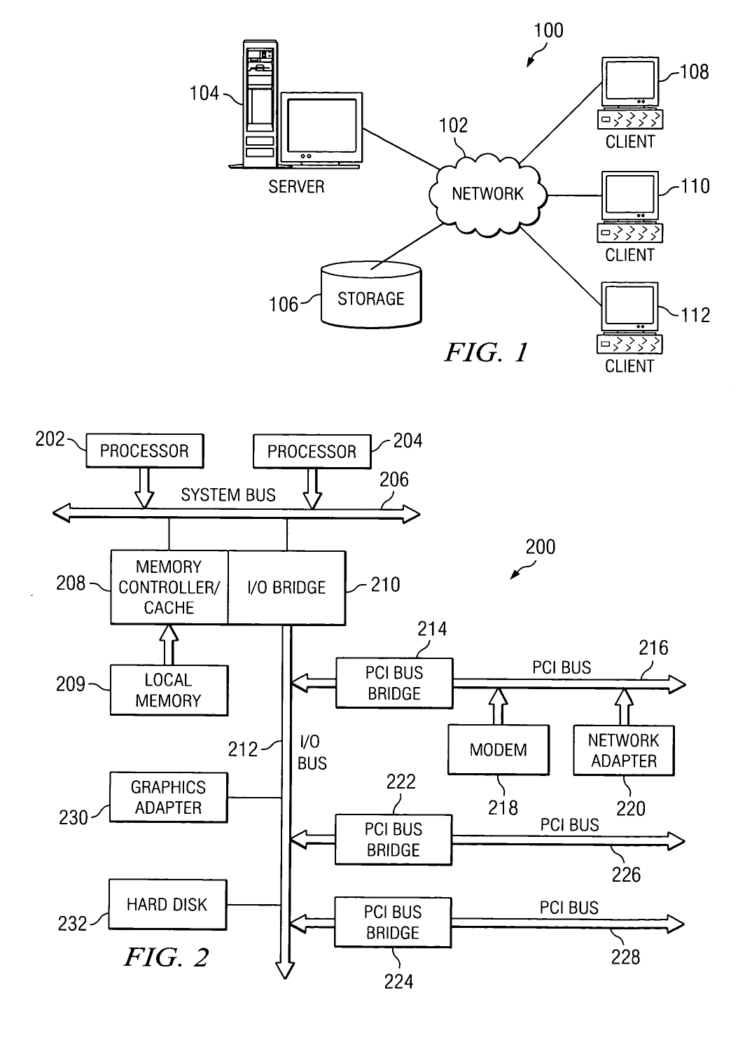

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. Clients 108, 110, and 112 may be, for example, personal computers or network computers. In the depicted example, server 104 provides data, such as boot files, operating system images, and applications to clients 108-112. Server 104 may be a web application server, such as, for example, IBM WebSphere Application Server, a product of International Business Machines Corporation located in Armonk, N.Y. Clients 108, 110, and 112 are clients to server 104. Network data processing system 100 may include additional servers, clients, and other devices not shown. In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in boards.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM eServer pSeries system, a product of International Business Machines Corporation in Armonk, N.Y., running the Advanced Interactive Executive (AIX) operating system or LINUX operating system.

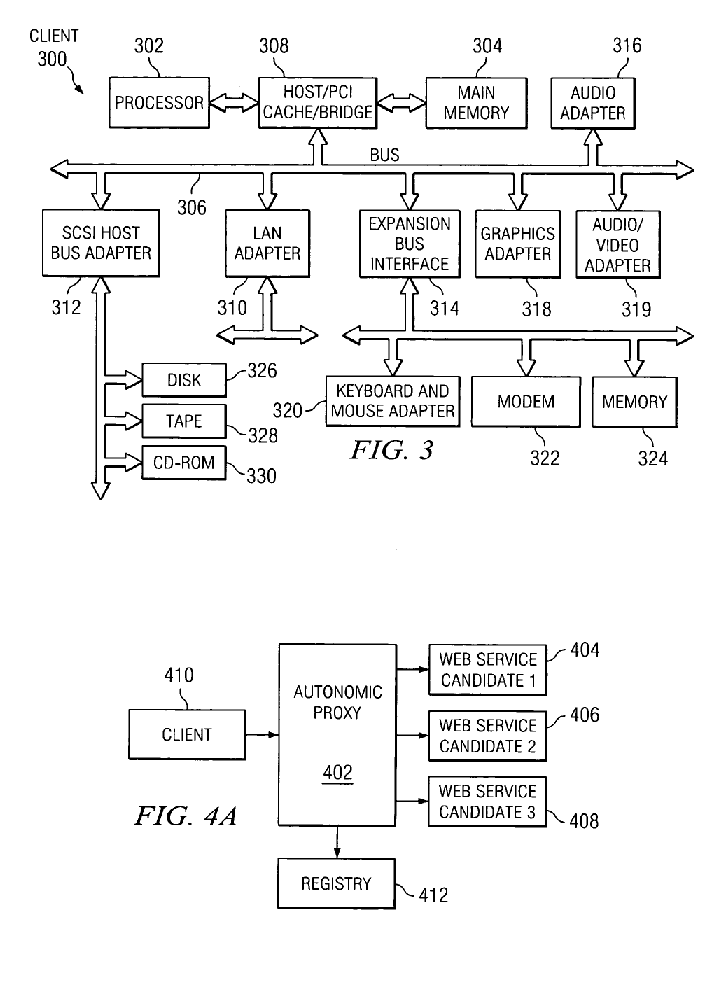

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, Small computer system interface (SCSI) host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. SCSI host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows XP, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash read-only memory (ROM), equivalent nonvolatile memory, or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interfaces As a further example, data processing system 300 may be a personal digital assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

The present invention is directed to a method, apparatus, and computer program product for dynamically selecting functionally equivalent Web services through a single autonomic proxy. The present invention addresses quality of service issues common in the Web service environment, such as failover, redundancy, performance, and security. The present invention may also apply the application of business policies, e.g., cost of the service, or preferred provider, in the determination of service invocation. The mechanism of the present invention dynamically tunes the Web service environment by allowing an autonomic proxy to determine which Web service, from multiple equivalent Web services, to invoke.

Web services may be invoked via defined interfaces that are described in forms that are discoverable by other software components over the network. Standard Web service interfaces may be defined by industry groups using industry standard WSDL to create WSDL service interface definition documents. These service descriptions, comprising of service interfaces and protocol bindings, and service location, may be queried to locate Web services that conform to the service interface and policy. A policy is a group of assertions that represent the capabilities, requirements, and general characteristics of technical or business entities. An example of an XML-based structure that provides the mechanisms needed to enable Web services applications to specify policy information is WS-Policy (Web Services Policy Framework). Ws-Policy provides a model and corresponding grammar to describe the policies of a Web service.

Current methods of discovering policy include locating the information in a public or private UDDI registry or decorating the WSDL with policy information. UDDI is an industry initiative for a universal business registry (catalog) of Web services. UDDI is designed to enable software to automatically discover and integrate with services on the Web. UDDI contains white pages (addresses and contacts), yellow pages (industry classification) and green pages (description of services). The green pages include the XML version, type of encryption and a document type definition (DTD) of the standard. UDDI messages ride on top of the simple object access protocol (SOAP), which invokes services on the Web.

Another mechanism for discovering Web services is WSIL. WSIL is a simple mechanism for Web service discovery that relies on service description mechanisms such as WSDL. WSIL approaches service discovery in a decentralized fashion, where service description information can be distributed to any location using a simple extensible XML document format. Although the invention is described using UDDI in particular, one of ordinary skill in the art will recognize that the teachings of the present invention are not limited to any particular form of discovery mechanism.

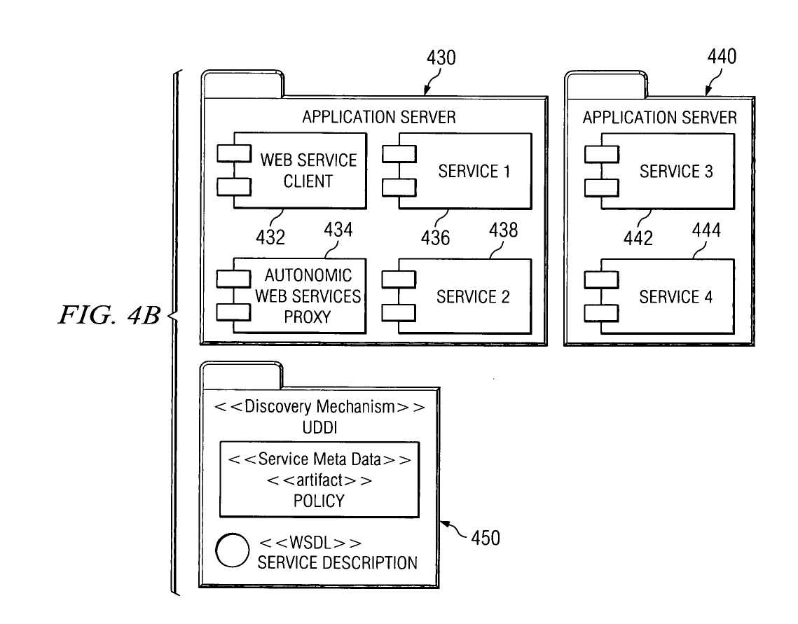

Turning next to FIG. 4A, a block diagram illustrating components used in dynamically selecting functionally equivalent Web application servers through a single autonomic proxy is depicted in accordance with a preferred embodiment of the present invention. In this preferred embodiment, each of the components depicted in FIG. 4A are implemented as Web services using the W3C Web Services Architecture. The various components depicted in FIG. 4A may be deployed in numerous ways across different data processing systems in an internet, intranet, or local area network.

In this example, autonomic proxy 402 is used to process requests from clients. Autonomic proxy 402 and Web service candidates 404, 406, and 408 may be implemented using a data processing system, such as data processing system 200 in FIG. 2. Clients may be, for example, client 410. These clients may be implemented, using a data processing system, such as data processing system 300 in FIG. 3.

When client 410 sends a request to locate a desired Web service, the request is received by autonomic proxy 402. In response to receiving this request, autonomic proxy 402 may query UDDI registry 412 using standard query patterns described in the UDDI Programmers API (UDDI 12). UDDI registry 412 stores information regarding Web services that may be utilized by clients. Since the UDDI standard supports organizing information according to category, UDDI registry 412 can be searched by category to retrieve entries that provide descriptive information (name, summary description, download location, price, vendor, license terms, etc.) about available software applications in a desired category (e.g., word processors, accounting software, etc.). Information retrieved from UDDI registry 412 is used by autonomic proxy 402 to identify candidate Web services for a client request.

FIG. 4B depicts an example configuration for dynamically selecting functionally equivalent Web application servers through a single autonomic proxy in accordance with a preferred embodiment of the present invention. This configuration illustrates that the present invention as described in FIG. 4A may be deployed in numerous ways across different data processing systems in an internet, intranet, or local area network. For example, FIG. 4B shows an application server 430 containing a client 432, an autonomic proxy 434, and Web services 436 and 438. In addition, application server 440 contains Web services 442 and 444. Client 432 may request a Web service through autonomic proxy 434, wherein the autonomic proxy selects the appropriate Web service candidates from the available Web services 436, 438, 442, and 444.

In addition, UDDI registry 450 may comprise policy information and a service description. UDDI utilizes a construct called tModels, which represent metadata describing how the Web service behaves, what conventions the Web service follows, or with what standards or services the Web service is compliant. For example, when a service interface is published in the UDDI registry using WSDL, the service interface is referred to as wsdlSpec tModel. A wsdlSpec tModel comprises a uniform resource locator (URL) pointer that points to the corresponding WSDL service interface definition document containing the technical specifications required to interact with the Web service endpoint.

Using the standard query patterns described in the UDDI Programmers API (UDDI 12), autonomic proxy 434 queries UDDI registry 450 to obtain a Web services definition language (WSDL) Web service interface description for the requested service. WSDL is a protocol for a Web service to describe its capabilities. WSDL describes the protocols and formats used by the service. WSDL service descriptions can be housed in a UDDI directory, such as UDDI registry 450, and the combination is used to promote the use of Web services worldwide. Based on knowledge of the specifications for the desired Web service, autonomic proxy 434 may discover a wsdlSpec tModel that identifies the desired services. Autonomic proxy 434 may then use the metadata in the wsdlSpec tModel to locate Web services that have registered an implementation of this wsdlSpec tModel.

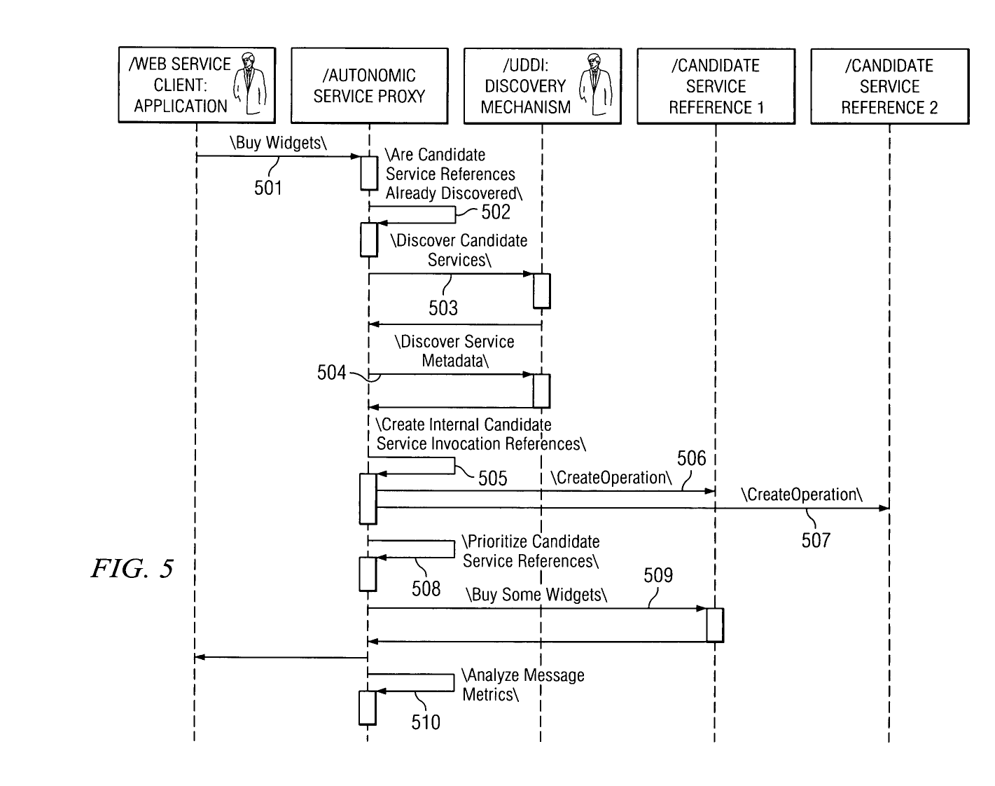

As mentioned previously, the present invention addresses the issues of failover, redundancy, and performance common in the Web service environment. In this manner, Web services that implement the same wsdlSpec tModel, or functionally equivalent Web services, may be found. FIG. 5 illustrates a diagram of the process of using the metadata in the wsdlSpec tModel to locate Web services that have registered an implementation of the wsdlSpec tModel in accordance with a preferred embodiment of the present invention.

The process begins with the Web service client sending a request for a Web service (step 501). In the example, the Web service client sends a request to buy widgets. The autonomic proxy receives the Web service client request and determines if the Web service candidate references have already been discovered (step 502). If so, these Web service candidates are used to service the Web service client request. If Web service candidate references have not been created for the request, the autonomic proxy queries the registry using standard query patterns to determine the Web service candidates for the client request (step 503). The registry may store information regarding Web services that may be utilized by clients and may be searched by category to retrieve entries that provide descriptive information (name, summary description, download location, price, vendor, license terms, etc.) about available software applications in a desired category (e.g., word processors, accounting software, etc.). As a result of the query, the autonomic proxy then obtains service metadata to locate one or more functionally equivalent Web services for the requested service (step 504). Based on the metadata for the requested service, the autonomic proxy may then create and store internal Web service candidate invocation references for the requested service (step 505). Once the autonomic proxy obtains candidate Web services, the autonomic proxy may create an instance of a candidate service for a first reference (step 506). The autonomic proxy may also create an instance of a candidate service for a second reference (step 507). The autonomic proxy then prioritizes the Web service candidate references (step 508). For example, the references may be prioritized based on Web service availability or response time or business criteria. Next, the autonomic proxy messages the selected Web service candidate to service the client request (step 509). The autonomic proxy then analyzes the message metrics to ensure if any of the policies established continue to be met (step 510). For example, if a policy for less than 1 second response time is in effect, and the request takes longer than this time, the policy is violated and the next candidate service reference should be used. In addition, the flexibility of the policy mechanism allows complex business rules to be modeled using the policies.

It must be noted that steps 503-508 as described above in FIG. 5 may be implemented independently of the method of request invocation. Proxy configuring steps 503-508 may also occur prior to the request invocation, such as predetermining the proxy configuration by instantiating the proxy every hour, for example.

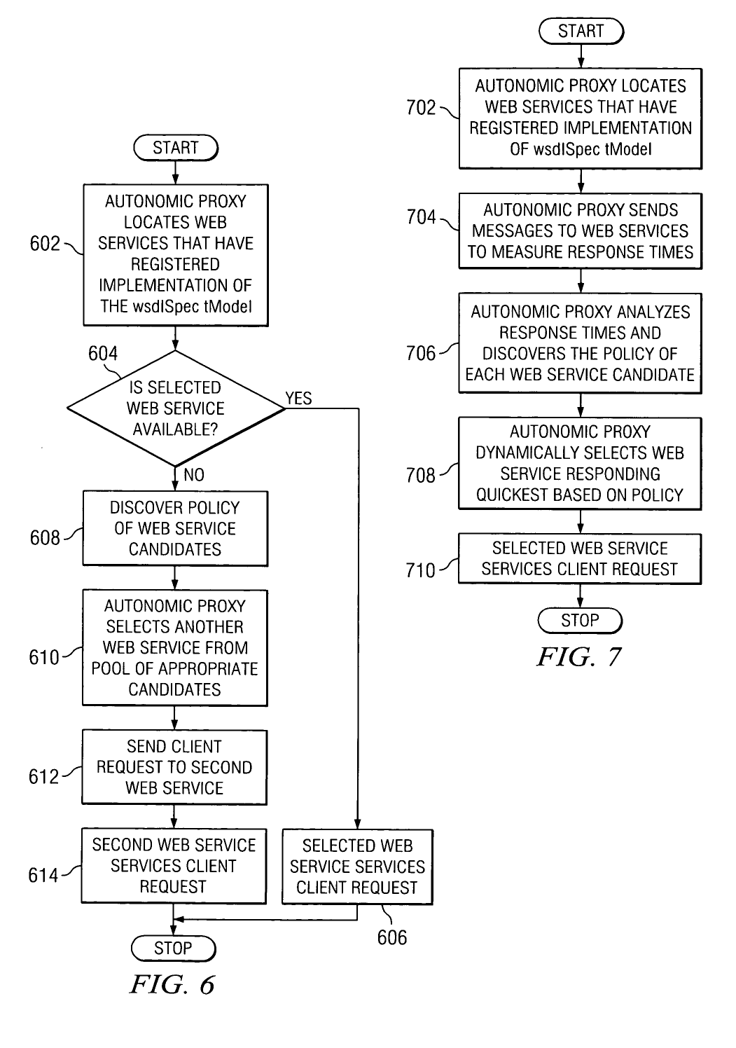

Turning now to FIG. 6, a flowchart of a process by which an autonomic proxy may automatically select the next appropriate service implementer to provide a degree of failover to the web service environment is depicted in accordance with a preferred embodiment of the present invention. When the autonomic proxy locates one or more Web services that have registered an implementation of the wsdlSpec tModel (step 602), before utilizing this selected Web service to service the client request, autonomic proxy sends a message to the Web service to determine if the selected Web service is available (i.e., the network link to the selected candidate is available) (step 604). If the selected Web service is available, the selected Web service may service the client request (step 606), the process terminating thereafter.

Turning back to step 604, if the autonomic proxy determines that the selected Web service is no longer available, the autonomic proxy may discover the policy of each Web service candidate in the group of Web service candidates (step 608), and select another Web service from the pool of appropriate candidates based on the policy (step 610). The autonomic proxy sends the client request to the newly selected Web service (step 612). The newly selected Web service may then service the client request (step 614), the process terminating thereafter. In this manner, the autonomic proxy may automatically select the next appropriate Web service implementer to provide a degree of failover and redundancy to the Web service environment.

Turning next to FIG. 7, a flowchart of a process by which an autonomic proxy may analyze the Web service response times and dynamically select the proxy responding the quickest is depicted in accordance with a preferred embodiment of the present invention. When the autonomic proxy locates one or more Web services that have registered an implementation of the wsdlSpec tModel (step 702), before utilizing this selected Web service to service the client request, autonomic proxy may measure the response times of each Web service by sending messages to each of the Web service candidates (step 704). The autonomic proxy may analyze the responses received and discover the policy of each Web service candidate in the group of Web service candidates (step 706). The autonomic proxy may then dynamically select the Web service that is responding the quickest according to the policy (step 708). The selected Web service may then service the client request (step 710), the process terminating thereafter. In this manner, the present invention may dynamically tune the Web service environment and select which Web service to invoke.

Thus, the present invention provides a method, apparatus, and computer program product for dynamically selecting functionally equivalent Web services through a single autonomic proxy. The advantages of the present invention should be apparent in view of the detailed description provided above. A proxy may be used to message a Web service returned from a wsdlSpec tModel search. However, conventional proxy implementations utilize only one of the Web services returned from the search. In contrast, the present invention provides a mechanism to address quality of service issues common in the Web service environment, such as failover, redundancy, performance, and security by providing an autonomic proxy to message multiple functionally equivalent Web services. In this manner, the proxy may dynamically determine which Web service to invoke. For example, if the network link to the original service provider is no longer available, the proxy may automatically select the next appropriate service implementer and dispatch the message again. This scheme provides a degree of failover and redundancy to the Web service environment. In addition, the autonomic proxy may dynamically tune the Web service environment to select the Web service that responds more quickly than the others. For example, the autonomic proxy may analyze the response times of the equivalent Web services and dynamically select the Web service that responds most quickly.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMS, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

1. A method for dynamically selecting functionally equivalent Web services through a single autonomic proxy, comprising:
receiving a client request to locate a Web service at the autonomic proxy;
querying a policy discovery mechanism based on the client request;
locating multiple Web services candidates to service the client request, wherein each Web service candidate is functionally equivalent to the other Web service candidates; and
determining which Web service candidate to invoke based on the Web service candidate business policy.

2. The method of claim 1, wherein the policy discovery mechanism is UDDI.

3. The method of claim 1, wherein the Web service is described using WSDL.

4. The method of claim 3, wherein querying the policy discovery mechanism includes obtaining a WSDL Web service interface description for the requested Web service.

5. The method of claim 3, wherein querying the policy discovery mechanism includes locating a wsdlSpec tModel based on the WSDL Web service interface description for the requested Web service.

6. The method of claim 1, wherein determining which Web service candidate to invoke based on the Web service candidate business policy includes analyzing business criteria of the Web service candidate.

7. The method of claim 6, wherein the business criteria includes cost of service.

8. The method of claim 1, further comprising:
selecting a Web service from a group of Web service candidates;
sending a message to the Web service;
in response to a determination that the Web service is not available, discovering the policy of each Web service candidate in the group of Web service candidates;
dynamically selecting a second Web service from the group of Web service candidates based on the policy; and
sending a request to the second Web service to service the client request.

9. The method of claim 1, further comprising:
analyzing a metadata about the client request.

10. The method of claim 9, wherein the metadata includes Web service response time information.

11. The method of claim 1, wherein the locating step includes
discovering the policy of each Web service candidate in the group of Web service candidates;
dynamically selecting the Web service from the group of Web service candidates responding the quickest based on the policy; and
sending a request to the selected Web service to service the client request.

12. The method of claim 1, wherein the business policy includes Web Services Policy Framework (WSPolicy).

13. A data processing system for dynamically selecting functionally equivalent Web services through a single autonomic proxy, comprising:
receiving means for receiving a client request to locate a Web service at the autonomic proxy;
querying means for querying a policy discovery mechanism based on the client request;
locating means for locating multiple Web services candidates to service the client request, wherein each Web service candidate is functionally equivalent to the other Web service candidates; and
determining means for determining which Web service candidate to invoke based on the Web service candidate business policy.

14. The data processing system of claim 13, wherein the policy discovery mechanism is UDDI.

15. The data processing system of claim 13, wherein the Web service is described using WSDL.

16. The data processing system of claim 15, wherein the querying means includes obtaining a WSDL Web service interface description for the requested Web service.

17. The data processing system of claim 15, wherein querying means includes locating a wsdlSpec tModel based on the WSDL Web service interface description for the requested Web service.

18. The data processing system of claim 13, wherein the determining means includes analyzing business criteria of the Web service candidate.

19. The data processing system of claim 18, wherein the business criteria includes cost of service.

20. The data processing system of claim 15, further comprising:
first selecting means for selecting a Web service from a group of Web service candidates;
first sending means for sending a message to the Web service;
discovering means for discovering the policy of each Web service candidate in the group of Web service candidates in response to a determination that the Web service is not available;
second selecting means for dynamically selecting a second Web service from the group of Web service candidates based on the policy; and
second sending means for sending a request to the second Web service to service the client request.

21. The data processing system of claim 13, further comprising:
analyzing means for analyzing a metadata about the client request.

22. The data processing system of claim 21, wherein the metadata includes Web service response time information.

23. The data processing system of claim 13, wherein the locating means includes
discovering means for discovering the policy of each Web service candidate in the group of Web service candidates;
selecting means for dynamically selecting the Web service from the group of Web service candidates responding the quickest based on the policy; and
sending means for sending a request to the selected Web service to service the client request.

24. The data processing system of claim 11, wherein the business policy includes Web Services Policy Framework (WSPolicy).

25. A computer program product in a computer readable medium for dynamically selecting functionally equivalent Web services through a single autonomic proxy, comprising:
first instructions for receiving a client request to locate a Web service at the autonomic proxy;
second instructions for querying a policy discovery mechanism based on the client request;
third instructions for locating multiple Web services candidates to service the client request, wherein each Web service candidate is functionally equivalent to the other Web service candidates; and
fourth instructions for determining which Web service candidate to invoke based on the Web service candidate business policy.

26. The computer program product of claim 25, wherein the policy discovery mechanism is UDDI.

27. The computer program product of claim 25, wherein the Web service is described using WSDL.

28. The computer program product of claim 27, wherein the querying instructions include obtaining a WSDL Web service interface description for the requested Web service.

29. The computer program product of claim 25, wherein the querying instructions include locating a wsdlSpec tModel based on the WSDL Web service interface description for the requested Web service.

30. The computer program product of claim 25, wherein the determining instructions include analyzing business criteria of the Web service candidate

31. The computer program product of claim 30, wherein the business criteria includes cost of service.

32. The computer program product of claim 25, further comprising:
fifth instructions for selecting a Web service from a group of Web service candidates;
sixth instructions for sending a message to the Web service;
seventh instructions for discovering the policy of each Web service candidate in the group of Web service candidates in response to a determination that the Web service is not available;
eighth instructions for dynamically selecting a second Web service from the group of Web service candidates based on the policy; and
ninth instructions for sending a request to the second Web service to service the client request.

33. The computer program product of claim 25, further comprising:
fifth instructions for analyzing a metadata about the client request.

34. The computer program product of claim 33, wherein the metadata includes Web service response time information.

35. The computer program product of claim 25, wherein the locating instructions include
instructions for discovering the policy of each Web service candidate in the group of Web service candidates;
instructions for dynamically selecting the Web service from the group of Web service candidates responding the quickest based on the policy; and
instructions for sending a request to the selected Web service to service the client request.

36. The computer program product of claim 25, wherein the business policy includes Web Services Policy Framework (WSPolicy).
